(19) United States
(12) Patent Application Publication
(10) Pub. No.: US 2026/0356428 A1
(43) Pub. Date: Nov. 12, 2026

(54) VEHICLE CONTROL DEVICE, VEHICLE CONTROL METHOD, AND NON-TRANSITORY RECORDING MEDIUM

(71) Applicant: TOYOTA JIDOSHA KABUSHIKI KAISHA, Toyota-shi, Aichi-ken (JP)

(72) Inventor: Yoshiki NAKATSURU, Tokyo-to (JP)

(73) Assignee: TOYOTA JIDOSHA KABUSHIKI KAISHA, Toyota-shi, Aichi-ken (JP)

(21) Appl. No.: 19/645,685

(22) Filed: Apr. 13, 2026

(30) Foreign Application Priority Data
May 8, 2025 (JP) 2025-078071

(51) Int. Cl. B62D 15/02

(52) U.S. Cl. CPC B62D 15/0265

(57) ABSTRACT

A vehicle control device acquires a detection result of a surrounding situation sensor which detect a surrounding situation of a host vehicle, and determines whether a steering operation has been performed in a first preceding vehicle which travels in a lane in which the host vehicle is traveling based on the detection result of the surrounding situation sensor. It is determined whether the steering operation has been performed in a second preceding vehicle which is located between the host vehicle and the first preceding vehicle and which travels in the lane based on the detection result of the surrounding situation sensor when it is determined that the steering operation has been performed in the first preceding vehicle.

### FIELD

The present disclosure relates to a vehicle control device, a vehicle control method, and a non-transitory recording medium.

### BACKGROUND

PTL 1 (JP 6539297 B2) discloses that when an obstacle such as a stopped vehicle or falling object is present in front of a preceding vehicle and the preceding vehicle takes action to avoid the obstacle, a host vehicle which follows the preceding vehicle recognizes the obstacle and takes action to avoid the obstacle similar to the preceding vehicle. PTL 1 discloses that since the front of the host vehicle is blocked by the preceding vehicle, the detection of the obstacle tends to be delayed, accordingly, it may be difficult to take action to avoid the obstacle with sufficient margin.

In the technology described in PTL 1, although information indicating the behavior of the preceding vehicle is used for the host vehicle to take action to avoid the front obstacle which is difficult to be recognized, information indicating the behavior of a further preceding vehicle which is located further ahead of the preceding vehicle (in other words, which is located on the opposite side of the host vehicle across the preceding vehicle) is not used. Therefore, in the technology described in PTL 1, it is not possible to easily and appropriately determine whether action to avoid the obstacle is necessary in the host vehicle when the obstacle such as the falling object which is difficult to be recognized is present in front of the host vehicle. A technology is desired that can easily and appropriately determine whether action to avoid the obstacle is necessary in the host vehicle when the obstacle such as the falling object which is difficult to be recognized is present in front of the host vehicle.

### SUMMARY

In view of the above-described points, it is an object of the present disclosure to provide a vehicle control device, a vehicle control method, and a non-transitory recording medium that can easily and appropriately determine whether action to avoid the obstacle is necessary in the host vehicle when the obstacle such as the falling object which is difficult to be recognized is present in front of the host vehicle.
(1) One aspect of the present disclosure is a vehicle control device including a processor configured to: acquire a detection result of a surrounding situation sensor which detect a surrounding situation of a host vehicle; and determine whether a steering operation has been performed in a first preceding vehicle which travels in a lane in which the host vehicle is traveling based on the detection result of the surrounding situation sensor, wherein the processor is configured to determine whether the steering operation has been performed in a second preceding vehicle which is located between the host vehicle and the first preceding vehicle and which travels in the lane based on the detection result of the surrounding situation sensor when it is determined that the steering operation has been performed in the first preceding vehicle.
(2) In the vehicle control device of the aspect (1), the processor may be configured to determine that an obstacle may be present in the lane when it is determined that the steering operation has been performed in the first preceding vehicle and is determined that the steering operation has been performed in the second preceding vehicle.
(3) In the vehicle control device of the aspect (1) or (2), the processor may be configured to perform a process to notify that steering operations have been performed consecutively in a plurality of preceding vehicles when it is determined that the steering operation has been performed in the first preceding vehicle and is determined that the steering operation has been performed in the second preceding vehicle.
(4) Another aspect of the present disclosure is a vehicle control method including: acquiring a detection result of a surrounding situation sensor which detect a surrounding situation of a host vehicle; and determining whether a steering operation has been performed in a first preceding vehicle which travels in a lane in which the host vehicle is traveling based on the detection result of the surrounding situation sensor, wherein it is determined whether the steering operation has been performed in a second preceding vehicle which is located between the host vehicle and the first preceding vehicle and which travels in the lane based on the detection result of the surrounding situation sensor when it is determined that the steering operation has been performed in the first preceding vehicle.
(5) Another aspect of the present disclosure is a non-transitory recording medium having recorded thereon a computer program for causing a processor to perform a process including: acquiring a detection result of a surrounding situation sensor which detect a surrounding situation of a host vehicle; and determining whether a steering operation has been performed in a first preceding vehicle which travels in a lane in which the host vehicle is traveling based on the detection result of the surrounding situation sensor, wherein it is determined whether the steering operation has been performed in a second preceding vehicle which is located between the host vehicle and the first preceding vehicle and which travels in the lane based on the detection result of the surrounding situation sensor when it is determined that the steering operation has been performed in the first preceding vehicle.

According to the present disclosure, it is possible to easily and appropriately determine whether action to avoid the obstacle is necessary in the host vehicle when the obstacle such as the falling object which is difficult to be recognized is present in front of the host vehicle.

### BRIEF DESCRIPTION OF DRAWINGS

FIG. 1 is a view showing an example of a host vehicle 1 to which a vehicle control device 14 of a first embodiment is applied.

FIG. 2 is a view for explaining an example of a situation in which preceding vehicles PV1, PV2 are present in a lane LN in which the host vehicle 1 is traveling.

FIG. 3 is a flowchart for explaining an example of a process performed by a processor 143 of the vehicle control device 14 of the first embodiment.

FIG. 4 is a view for explaining an example of determination position PD which is compared with an occurrence position P2 of a steering operation (avoidance action) of the preceding vehicle PV2 and the like.

### DESCRIPTION OF EMBODIMENTS

Below, referring to the drawings, embodiments of a vehicle control device, a vehicle control method, and a non-transitory recording medium of the present disclosure will be explained.

### First Embodiment

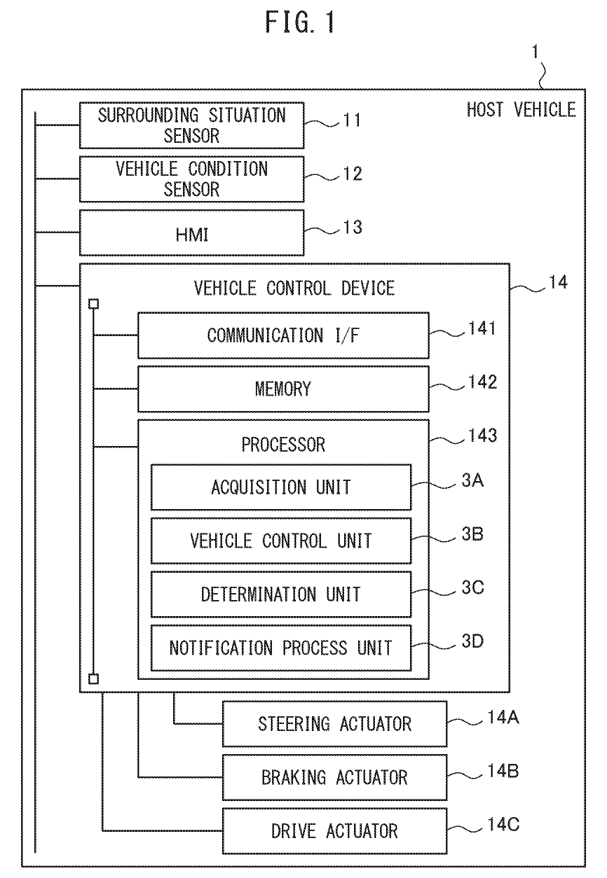

FIG. 1 is a view showing an example of a host vehicle 1 to which a vehicle control device 14 of a first embodiment is applied.

In the example shown in FIG. 1, the host vehicle 1 includes a surrounding situation sensor 11, a vehicle condition sensor 12, an HMI (Human Machine Interface) 13, the vehicle control device 14, a steering actuator 14A, a braking actuator 14B, and a drive actuator 14C.

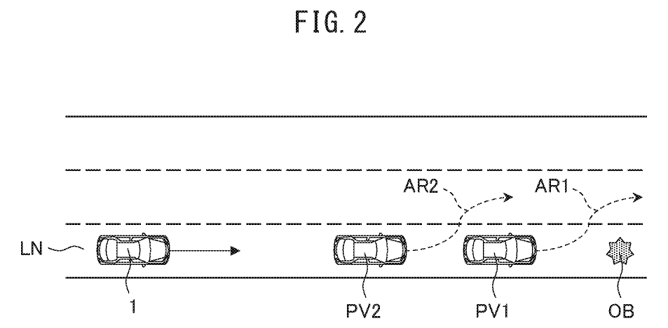

The surrounding situation sensor 11 detects a surrounding situation (such as preceding vehicles PV1, PV2 (refer to FIG. 2) which is traveling in a lane LN (refer to FIG. 2) in which the host vehicle 1 is traveling, an obstacle OB (refer to FIG. 2), pedestrians, and boundary lines defining the lane LN in which the host vehicle 1 is traveling) of the host vehicle 1, and transmits the detection result to the vehicle control device 14. The surrounding situation sensor 11 includes, for example, camera, LiDAR (Light Detection And Ranging), etc. In other words, the detection result of the surrounding situation sensor 11 includes, for example, an image of the front of the host vehicle 1 captured by the camera, the detection result of the LiDAR, or the like.

In another example, the surrounding situation sensor 11 may include a communication device which performs vehicle-to-vehicle communication, receives information of ITS (Intelligent Transport Systems), or the like. In other words, in this example, the detection result of the surrounding situation sensor 11 includes the communication result of the communication device which performs vehicle-to-vehicle communication, receives information of ITS, or the like.

In the example shown in FIG. 1, the vehicle condition sensor 12 detects the condition of the host vehicle 1 and sends the detection result to the vehicle control device 14. The vehicle condition sensor 12 includes, for example, a vehicle speed sensor, yaw rate sensor, etc.

The HMI 13 has the function of receiving various operations (such as operation to turn on Adaptive Cruise Control (ACC) or the like, steering operation, braking operation, accelerator operation (drive operation), etc.) by a driver of the host vehicle 1, and sends signals indicating the operations of the driver to the vehicle control device 14. Moreover, the HMI 13 has functions to provide various notifications to the driver of the host vehicle 1.

The vehicle control device 14 controls the steering actuator 14A, the braking actuator 14B, and the drive actuator 14C based on the information (data, signals) sent from the surrounding situation sensor 11, the vehicle condition sensor 12, and the HMI 13. The vehicle control device 14 is configured by a microcomputer equipped with a communication interface (I/F) 141, a memory 142, and a processor 143.

The communication interface 141 has an interface circuit for connecting the vehicle control device 14 to the surrounding situation sensor 11, the vehicle condition sensor 12, and the HMI 13. The memory 142 stores a program used in a process performed by the processor 143 and various data. The processor 143 has the function as an acquisition unit 3A, the function as a vehicle control unit 3B, the function as a determination unit 3C, and the function as a notification process unit 3D.

The acquisition unit 3A acquires the detection result of the surrounding situation sensor 11 from the surrounding situation sensor 11, acquires the detection result of the vehicle condition sensor 12 from the vehicle condition sensor 12, and acquires the signals indicating various operations by the driver of host vehicle 1 which the HMI 13 has received from the HMI 13.

The vehicle control unit 3B has the function to operate the steering actuator 14A, the braking actuator 14B, and the drive actuator 14C in accordance with the operation of the driver of host vehicle 1 which the HMI 13 has received, and the function (e.g., driving assistance function such as the ACC, or the like) to operate the steering actuator 14A, the braking actuator 14B, and the drive actuator 14C without requiring operations by the driver of host vehicle 1.

For example, when the ACC is ON and the preceding vehicle PV2 (refer to FIG. 2) exists in the lane LN (refer to FIG. 2) in which the host vehicle 1 is traveling, the vehicle control unit 3B operates the braking actuator 14B and the drive actuator 14C based on the detection result of the surrounding situation sensor 11 so that the host vehicle 1 follows the preceding vehicle PV2 and travels, without requiring operations by the driver of the host vehicle 1. Furthermore, when the ACC is ON and when the preceding vehicle PV1 (refer to FIG. 2), PV2 are not present in the lane LN in which the host vehicle 1 is traveling, the vehicle control unit 3B operates the braking actuator 14B and drive actuator 14C so that host vehicle 1 travels at a speed set by the driver without requiring operations by the driver of the host vehicle 1.

FIG. 2 is a view for explaining an example of a situation in which the preceding vehicles PV1, PV2 are present in the lane LN in which the host vehicle 1 is traveling.

In the example shown in FIG. 2, an obstacle OB such as falling object or the like is present in the lane LN in which the host vehicle 1 and the preceding vehicles PV1, PV2 are traveling.

If the preceding vehicles PV1, PV2 are not present in the lane LN in which the host vehicle 1 is traveling, for instance, the vehicle control device 14 can recognize the obstacle OB which is present in the lane LN in which the host vehicle 1 is traveling based on the image of the front of the host vehicle 1 captured by the camera as the surrounding situation sensor 11, the detection result of the LiDAR as the surrounding situation sensor 11, or the like. Additionally, the driver of the host vehicle 1 can also recognize the obstacle OB which is present in the lane LN in which the host vehicle 1 is traveling.

On the other hand, as shown in the example in FIG. 2, when the preceding vehicles PV1, PV2 are present in the lane LN in which the host vehicle 1 is traveling, for example, the vehicle control device 14 may not be able to recognize the obstacle OB which is present in the lane LN in which the host vehicle 1 is traveling based on the image of the front of the host vehicle 1 captured by the camera as the surrounding situation sensor 11, the detection result of the LiDAR as the surrounding situation sensor 11 or the like, and the driver of the host vehicle 1 may not be able to recognize the obstacle OB which is present in the lane LN in which the host vehicle 1 is traveling.

Therefore, in the example shown in FIG. 1, when the obstacle OB such as falling object or the like which is difficult to be recognized as in the example shown in FIG. 2 is present in the lane LN in which the host vehicle 1 is traveling, measures described later are implemented to easily and appropriately determine whether action to avoid the obstacle OB is necessary in the host vehicle 1.

If the obstacle OB is not present in the lane LN in which the host vehicle 1 is traveling, and if the steering operation drawing the trajectory indicated by a dashed arrow AR1 in FIG. 2 is not performed in the preceding vehicle PV1, for example, the vehicle control device 14 may not be able to recognize preceding vehicle PV1 which is located on the opposite side of the host vehicle 1 across the preceding vehicle PV2, based on the image of the front of the host vehicle 1 captured by the camera as the surrounding situation sensor 11 or the detection result of the LiDAR as the surrounding situation sensor 11.

On the other hand, when the steering operation drawing the trajectory indicated by the dashed arrow AR1 in FIG. 2 is performed in the preceding vehicle PV1 as in the example in FIG. 2, it is considered that, for example, the vehicle control device 14 can recognize the preceding vehicle PV1 based on the image of the front of the host vehicle 1 captured by the camera as the surrounding situation sensor 11 or the detection result of the LiDAR as the surrounding situation sensor 11.

Therefore, in the example shown in FIG. 1, the determination unit 3C determines whether the steering operation, for example, which draws the trajectory indicated by the dashed arrow AR1 in FIG. 2 (in other words, the steering operation to avoid the obstacle OB in the lane LN) is performed in the preceding vehicle PV1 traveling in the lane LN in which the host vehicle 1 is traveling based on the detection result of the surrounding situation sensor 11 (the image of the front of the host vehicle 1 captured by the camera as the surrounding situation sensor 11 or the detection result of the LiDAR as the surrounding situation sensor 11) acquired by the acquisition unit 3A.

Additionally, in the example shown in FIG. 1, when the determination unit 3C determines that the steering operation is performed in the preceding vehicle PV1, the determination unit 3C determines whether the steering operation, for example, which draws the trajectory indicated by a dashed arrow AR2 in FIG. 2 (in other words, the steering operation to avoid the obstacle OB in the lane LN) is performed in the preceding vehicle PV2 which is located between host vehicle 1 and the preceding vehicle PV1 and is traveling in the lane LN based on the detection result of surrounding situation sensor 11 (the image of the front of host vehicle 1 captured by the camera as the surrounding situation sensor 11 or the detection result of the LiDAR as the surrounding situation sensor 11) acquired by the acquisition unit 3A.

Furthermore, the determination unit 3C determines that the obstacle OB which needs to be avoided by the host vehicle 1 may be present in the lane LN in which the host vehicle 1 is traveling when the determination unit 3C determines that the steering operation, for example, which draws the trajectory indicated by the dashed arrow AR1 in FIG. 2 is performed in the preceding vehicle PV1 and when the determination unit 3C determines that the steering operation, for example, which draws the trajectory indicated by the dashed arrow AR2 in FIG. 2 is performed in the preceding vehicle PV2.

Furthermore, in the example shown in FIG. 1, when the determination unit 3C determines that the steering operation, for example, which draws the trajectory indicated by the dashed arrow AR1 in FIG. 2 is performed in the preceding vehicle PV1 and when the determination unit 3C determines that the steering operation, for example, which draws the trajectory indicated by the dashed arrow AR2 in FIG. 2 is performed in the preceding vehicle PV2, the notification process unit 3D performs a process to notify the driver of the host vehicle 1 that the steering operations have been performed consecutively in a plurality of preceding vehicles PV1, PV2 (specifically, a process to cause the HMI 13 to notify that the steering operations have been performed consecutively in the plurality of preceding vehicles PV1, PV2).

Therefore, in the example shown in FIG. 1, it is possible to easily and appropriately determine whether action to avoid the obstacle OB is necessary in the host vehicle 1 when the obstacle OB such as the falling object which is difficult to be recognized is present in front of the host vehicle 1.

Specifically, in the example shown in FIG. 1, when the ACC is in the ON state and when the determination unit 3C determines that the steering operation, for example, which draws the trajectory indicated by the dashed arrow AR1 in FIG. 2 is performed in the preceding vehicle PV1 and that the steering operation, for example, which draws the trajectory indicated by the dashed arrow AR2 in FIG. 2 is performed in the preceding vehicle PV2, the vehicle control unit 3B does not activate the drive actuator 14C to allow the host vehicle 1 to travel at the speed set by the driver (that is, execute switching from ACC control when the preceding vehicle is present to ACC control when the preceding vehicle is not present), but performs the braking operation which is necessary for safely performing the steering operation to avoid obstacle OB in the host vehicle 1 without requiring operations by the driver of host vehicle 1.

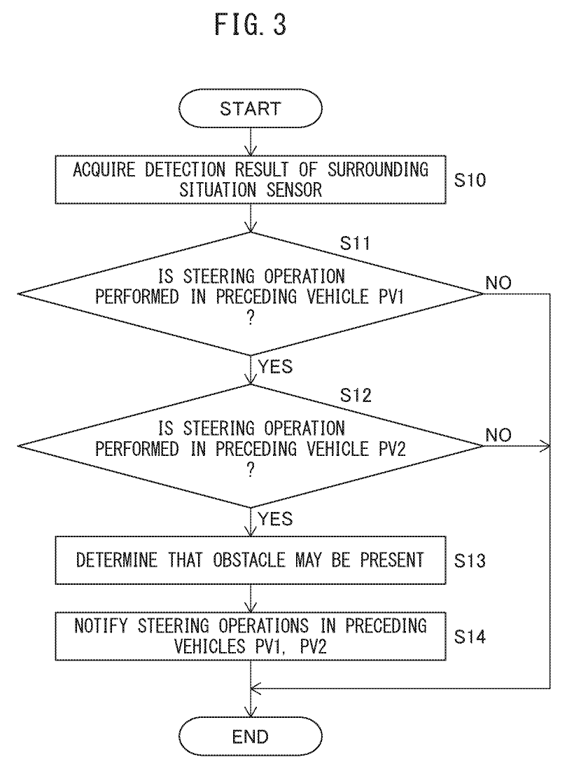

FIG. 3 is a flowchart for explaining an example of the process performed by the processor 143 of the vehicle control device 14 of the first embodiment.

In the example shown in FIG. 3, at step S10, acquisition unit 3A acquires the detection result of the surrounding situation sensor 11 (the image of the front of the host vehicle 1 captured by the camera as the surrounding situation sensor 11 or the detection result of the LiDAR as the surrounding situation sensor 11).

At step S11, the determination unit 3C determines whether the steering operation, for example, which draws the trajectory indicated by the dashed arrow AR1 in FIG. 2 (that is, the steering operation to avoid the obstacle OB in the lane LN) is performed in the preceding vehicle PV1 (further preceding vehicle) traveling in the lane LN in which the host vehicle 1 is traveling based on the detection result of surrounding situation sensor 11 acquired at step S10. When YES, it proceeds to step S12; when NO, it ends the process shown in FIG. 3.

At step S12, the determination unit 3C determines whether the steering operation, for example, which draws the trajectory indicated by the dashed arrow AR2 in FIG. 2 (that is, the steering operation to avoid the obstacle OB in the lane LN) is performed in the preceding vehicle PV2 which is located between host vehicle 1 and preceding vehicle PV1 (further preceding vehicle) and is traveling in the lane LN based on the detection result of surrounding situation sensor 11 acquired at step S10. When YES, it proceeds to step S13; when NO, it ends the process shown in FIG. 3.

At step S13, the determination unit 3C determines that the obstacle OB which needs to be avoided by the host vehicle 1 may be present in the lane LN in which the host vehicle 1 is traveling.

At step S14, the notification process unit 3D performs the process to notify the driver of host vehicle 1 that the steering operations have been performed consecutively in the plurality of preceding vehicles PV1, PV2 (specifically, the process to cause the HMI 13 to notify that the steering operations have been performed consecutively in the plurality of preceding vehicles PV1, PV2).

As described above, in the host vehicle 1 to which the vehicle control device 14 of the first embodiment is applied, safe avoidance actions of the host vehicle 1 for the obstacle OB, such as falling object, can be achieved not by attempting to detect and recognize the obstacle OB itself which is difficult to be detected and recognized, but by detecting and recognizing the steering operations of the preceding vehicles PV1, PV2 which avoid the obstacle OB, such as falling object.

### Second Embodiment

The host vehicle 1 to which the vehicle control device 14 of a second embodiment is applied is configured similarly to the host vehicle 1 to which the vehicle control device 14 of the first embodiment is applied, except for the points described later.

As described above, in the example shown in FIG. 1 (example of the host vehicle 1 to which the vehicle control device 14 of the first embodiment is applied), the determination unit 3C determines whether the steering operation, for example, which draws the trajectory indicated by the dashed arrow AR1 in FIG. 2 (the steering operation to avoid the obstacle OB in the lane LN) is performed in the preceding vehicle PV1 traveling in the lane LN in which the host vehicle 1 is traveling based on the detection result of the surrounding situation sensor 11 (the image of the front of the host vehicle 1 captured by the camera as the surrounding situation sensor 11 or the detection result of the LiDAR) acquired by the acquisition unit 3A. Furthermore, the determination unit 3C determines whether the steering operation, for example, which draws the trajectory indicated by the dashed arrow AR2 in FIG. 2 (the steering operation to avoid the obstacle OB in the lane LN) is performed in the preceding vehicle PV2 which is located between the host vehicle 1 and the preceding vehicle PV1 and is traveling in the lane LN based on the detection result of surrounding situation sensor 11 (the image of the front of the host vehicle 1 captured by the camera as the surrounding situation sensor 11 or the detection result of the LiDAR) acquired by the acquisition unit 3A.

On the other hand, in an example of the host vehicle 1 to which the vehicle control device 14 of the second embodiment is applied, the determination unit 3C determines whether the steering operation, for example, which draws the trajectory indicated by the dashed arrow AR1 in FIG. 2 (the steering operation to avoid the obstacle OB in the lane LN) is performed in the preceding vehicle PV1 traveling in the lane LN in which the host vehicle 1 is traveling based on the communication result of the communication device which performs vehicle-to-vehicle communication, receives information of ITS, or the like, which serves as the detection result of the surrounding situation sensor 11 acquired by the acquisition unit 3A. Furthermore, the determination unit 3C determines whether the steering operation, for example, which draws the trajectory indicated by the dashed arrow AR2 in FIG. 2 (the steering operation to avoid the obstacle OB in the lane LN) is performed in the preceding vehicle PV2 which is located between the host vehicle 1 and the preceding vehicle PV1 and is traveling in the lane LN based on the communication result of the communication device which performs vehicle-to-vehicle communication, receives information of ITS, or the like, which serves as the detection result of the surrounding situation sensor 11 acquired by the acquisition unit 3A.

### Third Embodiment

The host vehicle 1 to which the vehicle control device 14 of a third embodiment is applied is configured similarly to the host vehicle 1 to which the vehicle control device 14 of the first embodiment is applied, except for the points described later.

As stated above, in the example shown in FIG. 1 (the example of the host vehicle 1 to which the vehicle control device 14 of the first embodiment applied), when the determination unit 3C determines that the steering operation, for example, which draws the trajectory indicated by the dashed arrow AR1 in FIG. 2 (the steering operation to avoid the obstacle OB in the lane LN) is performed in the preceding vehicle PV1 traveling in the lane LN in which the host vehicle 1 is traveling and that the steering operation, for example, which draws the trajectory indicated by the dashed arrow AR2 in FIG. 2 (the steering operation to avoid the obstacle OB in the lane LN) is performed in the preceding vehicle PV2 which is located between the host vehicle 1 and the preceding vehicle PV1 and is traveling in the lane LN, an interval between a time point at which the steering operation of the preceding vehicle PV1 occurs and a time point at which the steering operation of the preceding vehicle PV2 occurs is not considered.

On the other hand, in an example of the host vehicle 1 to which the vehicle control device 14 of the third embodiment is applied, when the determination unit 3C determines that the steering operation to avoid the obstacle OB in the lane LN is performed in the preceding vehicle PV1 traveling in the lane LN in which the host vehicle 1 is traveling and that the steering operation to avoid the obstacle OB in the lane LN is performed in the preceding vehicle PV2 which is located between the host vehicle 1 and the preceding vehicle PV1 and is traveling in the lane LN, the interval between the time point at which the steering operation of the preceding vehicle PV1 occurs and the time point at which the steering operation of the preceding vehicle PV2 occurs is considered.

In detail, in the example of the host vehicle to which the vehicle control device 14 of the third embodiment is applied, when the interval between the time point at which the steering operation of the preceding vehicle PV1 occurs and the time point at which the steering operation of the preceding vehicle PV2 occurs is less than a time threshold, the determination unit 3C determines that the steering operation to avoid the obstacle OB in the lane LN is performed in the preceding vehicle PV1 traveling in the lane LN in which the host vehicle 1 is traveling and that the steering operation to avoid the obstacle OB in the lane LN is performed in the preceding vehicle PV2 which is located between the host vehicle 1 and the preceding vehicle PV1 and is traveling in the lane LN. On the other hand, when the interval between the time point at which the steering operation of the preceding vehicle PV1 occurs and the time point at which the steering operation of the preceding vehicle PV2 occurs is equal to or greater than the time threshold, the determination unit 3C does not determine that the steering operation to avoid the obstacle OB in the lane LN is performed in the preceding vehicle PV1 traveling in the lane LN in which the host vehicle 1 is traveling and that the steering operation to avoid the obstacle OB in the lane LN is performed in the preceding vehicle PV2 which is located between the host vehicle 1 and the preceding vehicle PV1 and is traveling in the lane LN.

The time threshold described above is set by considering the recognition reaction time of drivers of the preceding vehicles PV1, PV2 to the obstacle OB and the inter-vehicle distance between the preceding vehicle PV1 and the preceding vehicle PV2, for instance.

### Fourth Embodiment

The host vehicle 1 to which the vehicle control device 14 of a fourth embodiment is applied is configured similarly to the host vehicle 1 to which the vehicle control device 14 of the first embodiment is applied, except for the points described later.

As stated above, in the example shown in FIG. 1 (the example of the host vehicle 1 to which the vehicle control device 14 of the first embodiment applied), when the determination unit 3C determines that the steering operation, for example, which draws the trajectory indicated by the dashed arrow AR1 in FIG. 2 (the steering operation to avoid the obstacle OB in the lane LN) is performed in the preceding vehicle PV1 traveling in the lane LN in which the host vehicle 1 is traveling and that the steering operation, for example, which draws the trajectory indicated by the dashed arrow AR2 in FIG. 2 (the steering operation to avoid the obstacle OB in the lane LN) is performed in the preceding vehicle PV2 which is located between the host vehicle 1 and the preceding vehicle PV1 and is traveling in the lane LN, an occurrence position of the steering operation (avoidance action) of the preceding vehicle PV1 and an occurrence position of the steering operation (avoidance action) of the preceding vehicle PV2 are not considered.

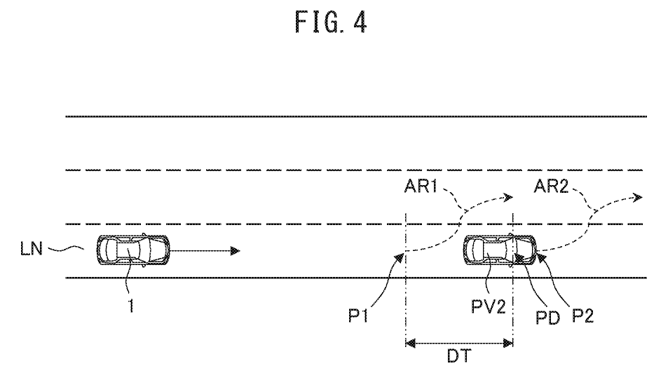

On the other hand, in the example of the host vehicle 1 to which the vehicle control device 14 of the fourth embodiment is applied, when the determination unit 3C determines that the steering operation to avoid the obstacle OB in the lane LN is performed in the preceding vehicle PV1 (further preceding vehicle) traveling in the lane LN in which the host vehicle 1 is traveling and that the steering operation to avoid the obstacle OB in the lane LN is performed in the preceding vehicle PV2 which is located between the host vehicle 1 and the preceding vehicle PV1 and is traveling in the lane LN, the occurrence position P1 (see FIG. 4) of the steering operation (avoidance action) of the preceding vehicle PV1 and the occurrence position P2 of the steering operation (avoidance action) of the preceding vehicle PV2 are considered.

FIG. 4 is a view for explaining an example of determination position PD which is compared with the occurrence position P2 of the steering operation (avoidance action) of the preceding vehicle PV2 and the like.

In the example of the host vehicle 1 to which the vehicle control device 14 of the fourth embodiment applied, when the steering operation (avoidance action) of the preceding vehicle PV2 has not occurred before the preceding vehicle PV2 passes the determination position PD (refer to FIG. 4) located a predetermined distance DT (refer to FIG. 4) ahead (right side of FIG. 4) of the travel direction of the host vehicle 1 relative to the occurrence position P1 (refer to FIG. 4) of the steering operation (avoidance action) of the preceding vehicle PV1 (further preceding vehicle) (i.e., when the occurrence position P2 (refer to FIG. 4) of the steering operation (avoidance action) of the preceding vehicle PV2 is ahead (right side of FIG. 4) of the travel direction of the host vehicle 1 relative to the determination position PD), the determination unit 3C does not determine that the steering operation to avoid the obstacle OB in the lane LN is performed in the preceding vehicle PV1 traveling in the lane LN in which the host vehicle 1 is traveling and that the steering operation to avoid the obstacle OB in the lane LN is performed in the preceding vehicle PV2 which is located between the host vehicle 1 and the preceding vehicle PV1 and is traveling in the lane LN.

In other words, in the example shown in FIG. 4, because the occurrence position P2 of the steering operation (avoidance action) of the preceding vehicle PV2 is ahead (right side of FIG. 4) of the travel direction of the host vehicle 1 relative to the determination position PD, the determination unit 3C does not determine that the steering operation to avoid the obstacle OB in the lane LN is performed in the preceding vehicle PV1 traveling in the lane LN in which the host vehicle 1 is traveling and that the steering operation to avoid the obstacle OB in the lane LN is performed in the preceding vehicle PV2 which is located between the host vehicle 1 and the preceding vehicle PV1 and is traveling in the lane LN.

On the other hand, when the occurrence position P2 of the steering operation (avoidance action) of the preceding vehicle PV2 is behind (left side of FIG. 4) the determination position PD in the travel direction of the host vehicle 1, the determination unit 3C determines that the steering operation to avoid the obstacle OB in the lane LN is performed in the preceding vehicle PV1 traveling in the lane LN in which the host vehicle 1 is traveling and that the steering operation to avoid the obstacle OB in the lane LN is performed in the preceding vehicle PV2 which is located between the host vehicle 1 and the preceding vehicle PV1 and is traveling in the lane LN.

As described above, although the embodiments of the vehicle control device, the vehicle control method, and the non-transitory recording medium of the present disclosure have been described with reference to the drawings, the vehicle control device, the vehicle control method, and the non-transitory recording medium of the present disclosure are not limited to the embodiments described above, and may be appropriately changed without departing from the scope of the present disclosure. The configuration of each example of the embodiment described above may be appropriately combined. In each example of the above-described embodiment, the process performed in the vehicle control device 14 has been described as software process performed by executing the program, but the process performed in the vehicle control device 14 may be process performed by hardware. Alternatively, the process performed by the vehicle control device 14 may be a combination of both software and hardware. Further, the program (program for realizing the function of the processor 143 of the vehicle control device 14) stored in the memory 142 of the vehicle control device 14 may be recorded in a computer-readable storage medium (non-transitory recording medium) such as, semiconductor memory, magnetic recording medium, optical recording medium, or the like for providing, distribution or the like.

What is claimed is:

1. A vehicle control device comprising a processor configured to:
acquire a detection result of a surrounding situation sensor which detect a surrounding situation of a host vehicle; and
determine whether a steering operation has been performed in a first preceding vehicle which travels in a lane in which the host vehicle is traveling based on the detection result of the surrounding situation sensor,
wherein the processor is configured to determine whether the steering operation has been performed in a second preceding vehicle which is located between the host vehicle and the first preceding vehicle and which travels in the lane based on the detection result of the surrounding situation sensor when it is determined that the steering operation has been performed in the first preceding vehicle.

2. The vehicle control device according to claim 1, wherein the processor is configured to determine that an obstacle may be present in the lane when it is determined that the steering operation has been performed in the first preceding vehicle and is determined that the steering operation has been performed in the second preceding vehicle.

3. The vehicle control device according to claim 1, wherein the processor is configured to perform a process to notify that steering operations have been performed consecutively in a plurality of preceding vehicles when it is determined that the steering operation has been performed in the first preceding vehicle and is determined that the steering operation has been performed in the second preceding vehicle.

4. A vehicle control method comprising:
acquiring a detection result of a surrounding situation sensor which detect a surrounding situation of a host vehicle; and
determining whether a steering operation has been performed in a first preceding vehicle which travels in a lane in which the host vehicle is traveling based on the detection result of the surrounding situation sensor,
wherein it is determined whether the steering operation has been performed in a second preceding vehicle which is located between the host vehicle and the first preceding vehicle and which travels in the lane based on the detection result of the surrounding situation sensor when it is determined that the steering operation has been performed in the first preceding vehicle.

5. A non-transitory recording medium having recorded thereon a computer program for causing a processor to perform a process comprising:
acquiring a detection result of a surrounding situation sensor which detect a surrounding situation of a host vehicle; and
determining whether a steering operation has been performed in a first preceding vehicle which travels in a lane in which the host vehicle is traveling based on the detection result of the surrounding situation sensor,
wherein it is determined whether the steering operation has been performed in a second preceding vehicle which is located between the host vehicle and the first preceding vehicle and which travels in the lane based on the detection result of the surrounding situation sensor when it is determined that the steering operation has been performed in the first preceding vehicle.
